(19) United States
(12) Patent Application Publication
(10) Pub. No.: US 2018/0123927 A1
(43) Pub. Date: May 3, 2018

(54) METHOD AND DEVICE FOR DETECTING NETWORK PACKET LOSS BASED ON SOFTWARE DEFINED NETWORK

(71) Applicants: NANNING FUGUI PRECISION INDUSTRIAL CO., LTD., Nanning (CN); HON HAI PRECISION INDUSTRY CO., LTD., New Taipei (TW)

(72) Inventor: YAO-WEN CHANG, New Taipei (TW)

(21) Appl. No.: 15/336,759

(22) Filed: Oct. 27, 2016

(51) Int. Cl. H04L 12/26; H04L 29/06

(52) U.S. Cl. CPC H04L 43/0829; H04L 69/22

(57) ABSTRACT

A method for detecting loss of network packets based on SDN includes selecting a data stream on a network path where the network path includes a plurality of switches. Start marking packet and end marking packet are created by a controller and the start marking packet is inserted in the data stream flowing through the first switch. After a time interval, the end marking packet is inserted. The respective arrivals of the start and end marking packets are reported to the controller by each switch on the network path. An absolute packet value between the start marking packet and the end marking packet flowing through each switch is calculated and a ratio of loss of network packets is calculated. The network path is adjusted and optimized according to the network packet loss ratios.

### FIELD

The present disclosure generally relates to communication technology.

### BACKGROUND

Currently, a method for detection network packet loss based on Software Defined Network (SDN) is that the controller periodically obtains the status information of the port from the switch. In a network of small size, the controller can search all the switches to obtain their port status for selections network. However, in a large-scale network, the controller searching out all switch ports to obtain its status takes inordinate time, especially when there is a great number of switch ports. In this case, the controller can not accurately and timely reflect the current state of the network. Another end-to-end detection method, from the server to the client, can detect packet loss quickly, but cannot immediately determine where the packet is on the network and its status as existing or lost.

### BRIEF DESCRIPTION OF THE DRAWINGS

Implementations of the present technology will now be described, by way of example only, with reference to the attached figures.

FIG. 1 illustrates an embodiment of functional modules of a device for detecting network packet loss based on SDN;

FIG. 2 illustrates an embodiment of an SDN controller selecting a network path and creating a start marking packet and an end marking packet;

FIG. 3 illustrates an embodiment of the SDN controller inserting the start marking packet and the end marking packet;

FIG. 4 illustrates an embodiment of the SDN controller recording the start marking packet and the end marking packet;

FIG. 5 illustrates an embodiment of the SDN controller calculating an absolute packet value between the start marking packet and the end marking packet;

FIG. 6a and FIG. 6b illustrates an embodiment of the SDN controller adjusting the network path according to a network packet loss ratio;

FIG. 7 illustrates an embodiment of a marking packet; and

FIG. 8 illustrates a flowchart of an embodiment of a method for detecting network packet loss based on SDN.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

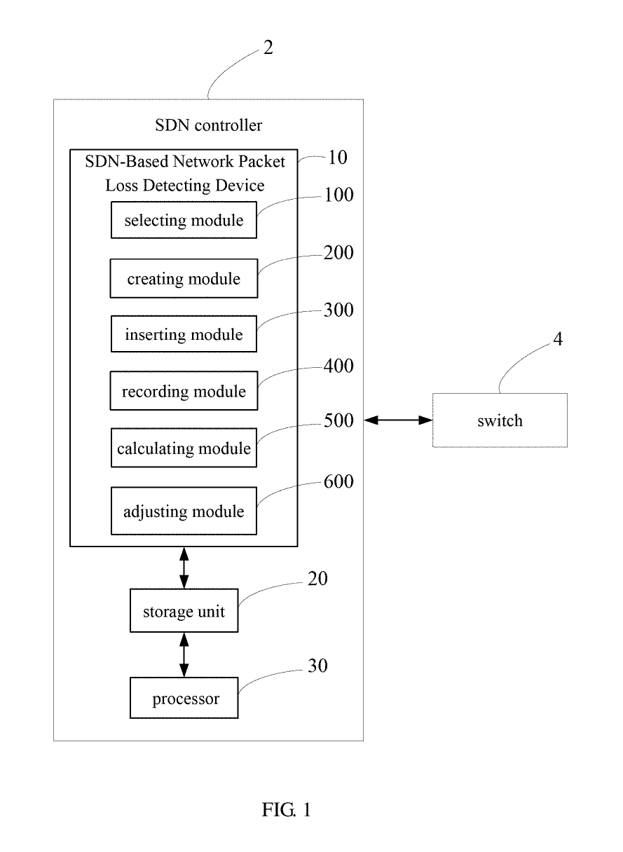

FIG. 1 illustrates an embodiment of function modules of a control device (SDN controller 2) for detecting network packet loss based on SDN. In the illustrated embodiment, the SDN controller 2 includes a SDN-based network packet loss detecting device 10, a storage unit 20, and a processor 30. Through the internet, the SDN controller 2 connects to one or more switches 4. The SDN-based network packet loss detecting device 10 is used to adjust network path by calculating the absolute packet value in marking packets through each switches 4, to detect loss of packets in network.

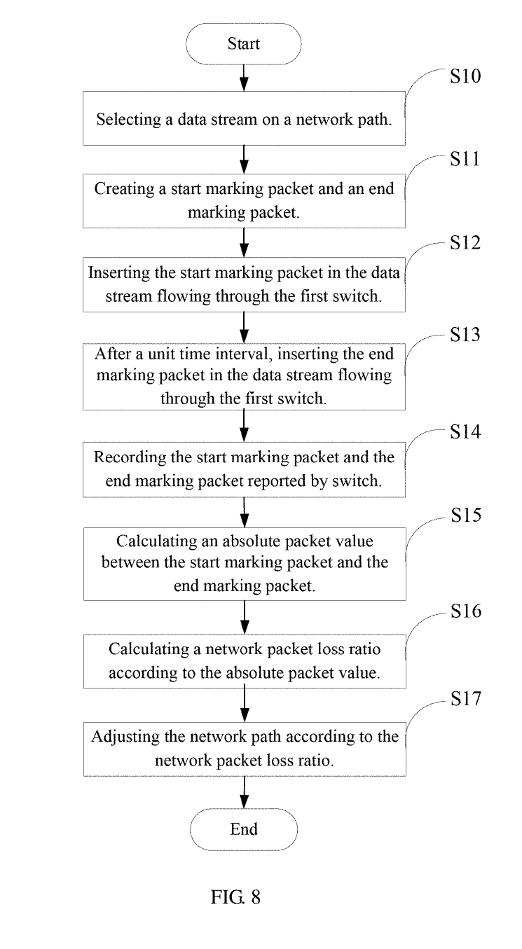

In one embodiment, the SDN-based network packet loss detecting device 10 includes a selecting module 100, a creating module 200, an inserting module 300, a recording module 400, a calculating module 500, and an adjusting module 600. One or more of the function modules include computerized code in the form of one or more programs that are stored in the storage unit 20 and executed by the processor 30 to provide functions of the SDN-based network packet loss detecting device 10. The storage unit 20 can be a dedicated memory, such as an EPROM, or a flash memory. Descriptions of the functions of the modules 100-600 are given with reference to FIG. 8.

FIG. 8 presents a flowchart of a method for detecting network packet loss based on SDN. The detecting method is provided by way of example, as there are a variety of ways to carry out the method. The method described below can be carried out using the configurations illustrated in FIG. 1, for example, and various elements of these figures are referenced in explaining the detecting method. Each block shown in FIG. 8 represents one or more processes, methods, or subroutines, carried out in the exemplary detecting method. Additionally, the illustrated order of blocks is by example only and the order of the blocks can change. The detecting method can begin at block S10.

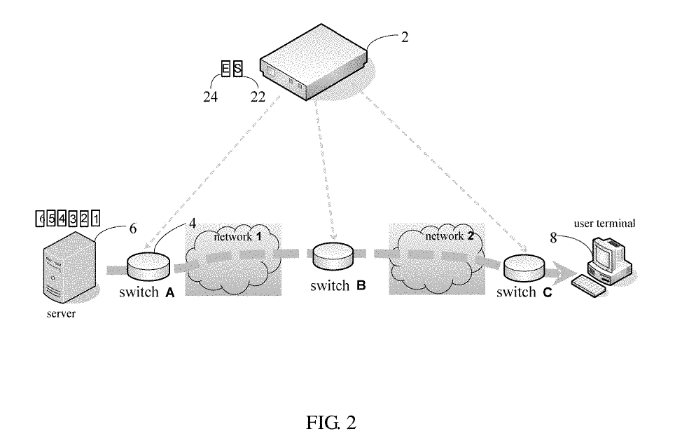

At block S10, via the selecting module 100, the SDN controller 2 selects a data stream on a network path, the network path includes a plurality of switches. The network path selected is either a single path or all paths managed by the SDN controller 2. Referring to FIG. 2, an embodiment of the selecting module 100 the network path selected includes switch A, switch B, and switch C.

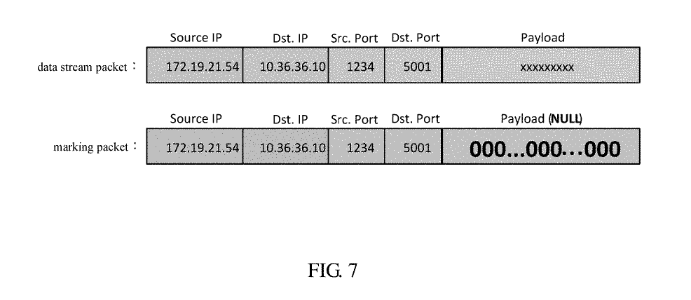

At block S11, via the creating module 200, the SDN controller 2 creates a start marking packet 22 and an end marking packet 24, as shown in FIG. 2. In one embodiment, the start marking packet header and the end marking packet header are same as packet header of data stream, but a payload of the start marking packet and of the end marking packet is set to 0, as shown in FIG. 7.

At block S12, via the inserting module 300, the SDN controller 2 inserts the start marking packet 22 in the data stream flowing through the first switch.

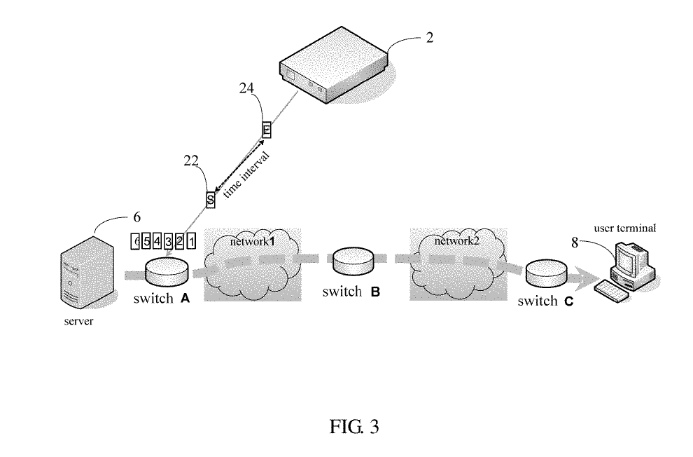

At block S13, after a time interval and via the inserting module 330, the SDN controller 2 inserts the end marking packet 24 in the data stream flowing through the first switch. Referring to FIG. 3, an embodiment of the SDN controller 2 inserts the start marking packet 22 and the end marking packet 24 in the data stream flowing through the switch A.

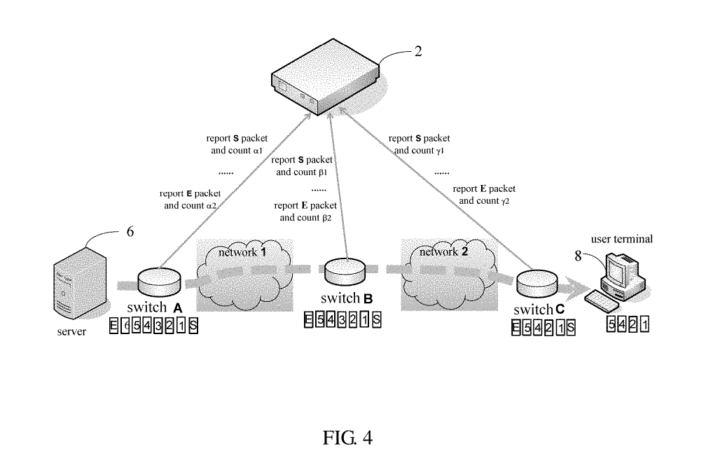

At block S14, via the recording module 400, the SDN controller 2 records the start marking packet 22 and the end marking packet 24 being respectively reported by each switch on the network path. The start marking packet 22 and the end marking packet 24 are discarded after the recording module 400 has recorded the start marking packet 22 and the end marking packet 24 reported by a last switch on the network path. Referring to FIG. 4, in one embodiment, the switch A reports to the SDN controller 2 after detecting the start marking packet 22 and reports the packet count α1 at that time. The switch A reports to the SDN controller 2 after detecting the end marking packet 24 and reports the packet count α2 at that time. The switch B reports to the SDN controller 2 after detecting the start marking packet 22 and reports the packet count β1 at that time. The switch B reports to the SDN controller 2 after detecting the end marking packet 24 and reports the packet count β2 at that time. The switch C reports to the SDN controller 2 after detecting the start marking packet 22 and reports the packet count γ1 at that time. The switch C reports to the SDN controller 2 after detecting the end marking packet 24 and reports the packet count γ2 at that time.

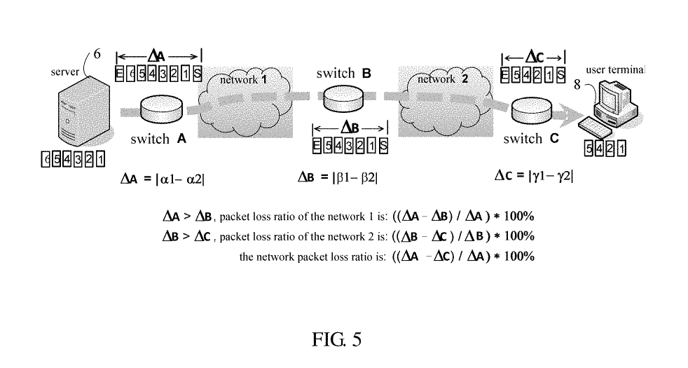

At block S15, via the calculating module 500, the SDN controller 2 calculates an absolute packet value between the start marking packet 22 and the end marking packet 24 in the data stream flowing through each switch. The SDN controller 2 begins the calculation when each switch detects and reports the start marking packet 22. Referring to FIG. 5, in one embodiment, the absolute packet value of the data stream through the switch A per time interval is ΔA=|α1-α2|, the absolute packet value of the data stream through the switch B per time interval is ΔB=|β1-β2|, and the absolute packet value of the data stream through the switch B per unit time interval is ΔC=|γ1-γ2|.

At block S16, via the calculating module 500, the SDN controller 2 calculates a network packet loss ratio according to the absolute packet value. Referring to FIG. 5, in one embodiment, the packet loss ratio of the network 1 between the switch A and switch B is ((ΔA−ΔB)/ΔA)*100%, and the packet loss ratio of the network 2 between the switch B and switch C is ((ΔB −ΔC)/ΔB)*100%. The network packet loss ratio of the (final) network path between the server 6 and the user terminal 8 is ((ΔA−ΔC)/ΔA)*100%.

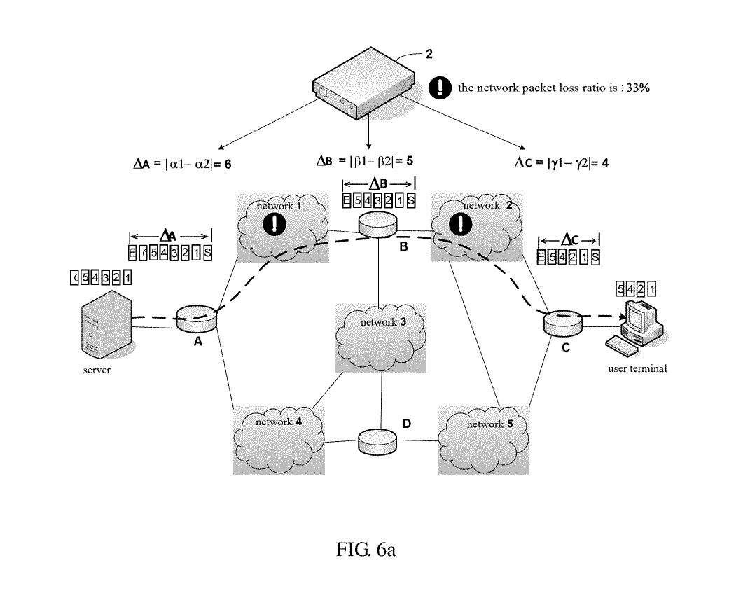

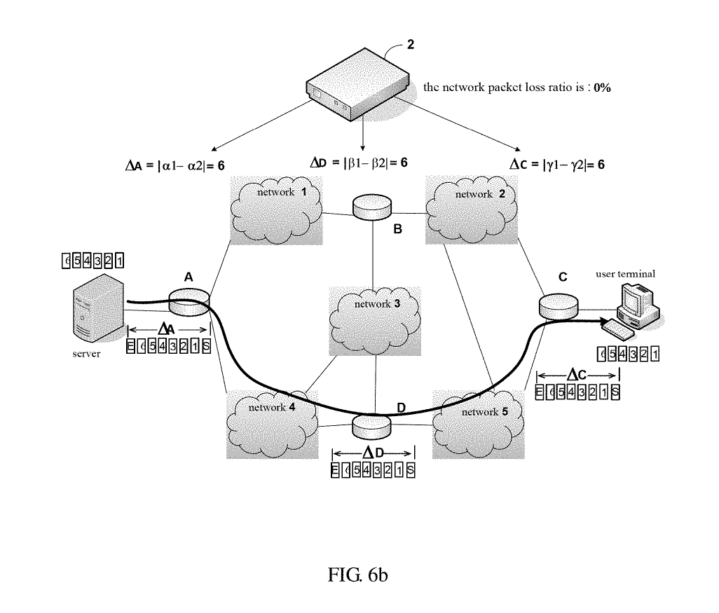

At block S17, via the adjusting module 600, the SDN controller 2 adjusts the network path according to the network packet loss ratio. Referring to FIG. 6a, in one embodiment, the SDN controller 2 calculates the network packet loss ratio of the network path server 6→switch A→network 1→switch B→network 2→switch C→user terminal 8. In the embodiment, the packet loss ratio of the network 1 is ((ΔA−ΔB)/ΔA)*100%=16.7%, the packet loss ratio of the network 2 is ((ΔB−ΔC)/ΔB)*100%=20%, and the final network packet loss ratio is ((ΔA−ΔC)/ΔA)*100%=33%. Referring to FIG. 6b, in another embodiment, the SDN controller 2 calculates the network packet loss ratio of another network path server 6→switch A→network 4→switch D→network 5→switch C→user terminal 8. In the embodiment, the packet loss ratio of the network 4 is ((ΔA−ΔB)/ΔA)*100%=0%, the packet loss ratio of the network 5 is ((ΔB−ΔC)/ΔB)*100%=0%, and the final network packet loss ratio is ((ΔA−ΔC)/ΔA)*100%=0%. The SDN controller 2 can select a network path for transmitting data stream with a smaller network packet loss ratio by comparing the network packet loss ratios of the two paths.

The embodiments shown and described above are only examples. Many details are often found in the art such as the other features of an SDN controller. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for detecting network packet loss based on Software Defined Network (SDN), applied to a SDN controller, the method comprising:
selecting a data stream on a network path, and the network path including a plurality of switches;
creating a start marking packet and an end marking packet;
inserting the start marking packet in the data stream flowing through the first switch;
after a time interval, inserting the end marking packet in the data stream flowing through the first switch;
recording the start marking packet and the end marking packet being respectively reported by each switch on the network path;
calculating an absolute packet value between the start marking packet and the end marking packet in the data stream flowing through each switch;
calculating a network packet loss ratio according to the absolute packet value; and
adjusting the network path according to the network packet loss ratio.

2. The method as claimed in claim 1, wherein the network path selected is either a single path or all paths managed by the SDN controller.

3. The method as claimed in claim 1, wherein the start marking packet header and the end marking packet header are same as packet header of data stream, but a payload of the start marking packet and of the end marking packet is set to 0.

4. The method as claimed in claim 1, further comprises:
discarding the start marking packet and the end marking packet when the start marking packet and the end marking packet reported by last switch on the network path.

5. The method as claimed in claim 1, further comprising:
the SDN controller begins to calculate packet value flowing through the switch when each switch detects and reports the start marking packet.

6. A device for detecting network packet loss based on SDN, applied to a SDN controller, the device comprising:
at least one processor;
a storage system; and
one or more programs that are stored in the storage system and executed by the at least one processor, the one or more programs comprising instructions for:
the SDN controller selecting a data stream on a network path, and the network path including a plurality of switches;
the SDN controller creating a start marking packet and an end marking packet;
the SDN controller inserting the start marking packet in the data stream flowing through the first switch;
after a unit time interval, the SDN controller inserting the end marking packet in the data stream flowing through the first switch;
the SDN controller recording the start marking packet and the end marking packet being respectively reported by each switch on the network path;
the SDN controller calculating an absolute packet value between the start marking packet and the end marking packet in the data stream flowing through each switch;
the SDN controller calculating a network packet loss ratio according to the absolute packet value; and
the SDN controller adjusting the network path according to the network packet loss ratio.

7. The device as claimed in claim 6, wherein the network path selected is either a single path or all paths managed by the SDN controller.

8. The device as claimed in claim 6, wherein the start marking packet header and the end marking packet header are same as packet header of data stream, but a payload of the start marking packet and of the end marking packet is set to 0.

9. The device as claimed in claim 6, further comprises instructions for:
discarding the start marking packet and the end marking packet when the start marking packet and the end marking packet reported by last switch on the network path.

10. The device as claimed in claim 6, further comprises instructions for:
the SDN controller begins to calculate packet value flowing through the switch when each switch detects and reports the start marking packet.
